(19) United States
(12) Patent Application Publication
(10) Pub. No.: US 2015/0183409 A1
(43) Pub. Date: Jul. 2, 2015

(54) VEHICLE ASSISTANCE DEVICE AND METHOD

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(73) Assignee: HON HAI PRECISION INDUSTRY CO., LTD., New Taipei (TW)

(21) Appl. No.: 14/252,427

(22) Filed: Apr. 14, 2014

(30) Foreign Application Priority Data
Dec. 27, 2013 (TW) 102148598

(51) Int. Cl. B60T 7/12

(52) U.S. Cl. CPC B60T 7/12

(57) ABSTRACT

Exemplary vehicle assistance method includes obtaining a speed of a vehicle. The method then determines whether the vehicle is moving according to the obtained speed of the vehicle. If yes, the method obtains an image of a driver's seat of the vehicle captured by a camera. The method then creates a 3D model of the driver's seat corresponding to the obtained images of the driver's seat. Next, the method compares the created 3D model of the driver's seat with stored preset 3D models of a person sitting in the driver's seat to determine whether a person occupies the driver's seat. If no, the method controls a driving unit to drive a pushing unit to engage a handbrake of the vehicle.

### FIELD

The present disclosure relates to vehicle assistance devices, and particularly to a vehicle assistance device assisting a vehicle to automatically engage a handbrake when moving when no one is in the driver's seat and a related method.

### BACKGROUND

A driver can engage a handbrake after a vehicle is parked to prevent the vehicle from moving when parked on a sloped or uneven surface.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an embodiment of a vehicle assistance device.

FIG. 2 is a diagrammatic view of an embodiment of a camera capturing an image of a driver's seat.

FIG. 3 is a diagrammatic view of an embodiment of a vehicle on a sloped surface when parked.

FIG. 4 is a flowchart of an embodiment of a vehicle assistance method.

### DETAILED DESCRIPTION

The embodiments of the present disclosure are now described in detail, with reference to the accompanying drawings.

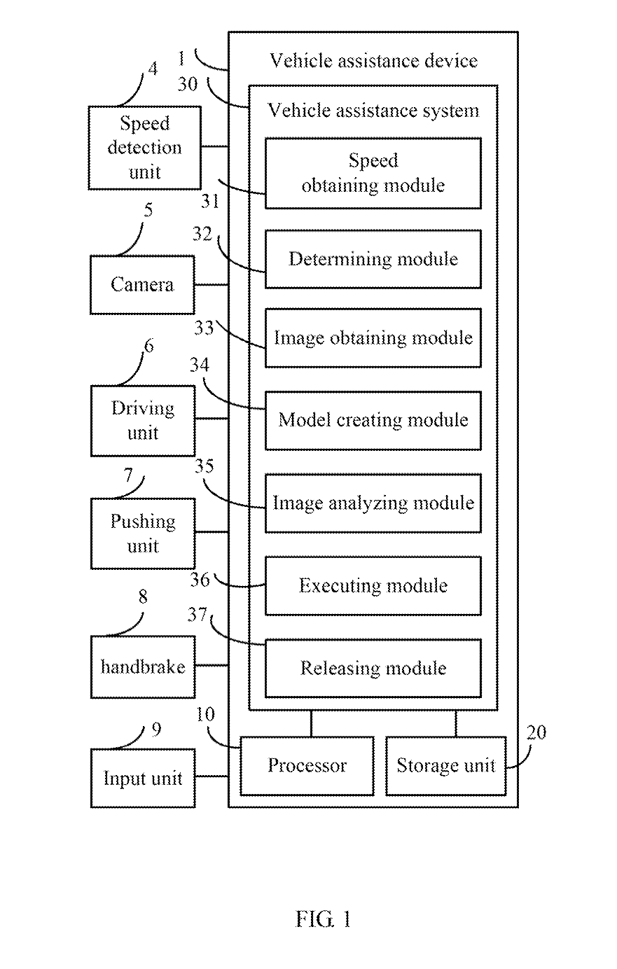

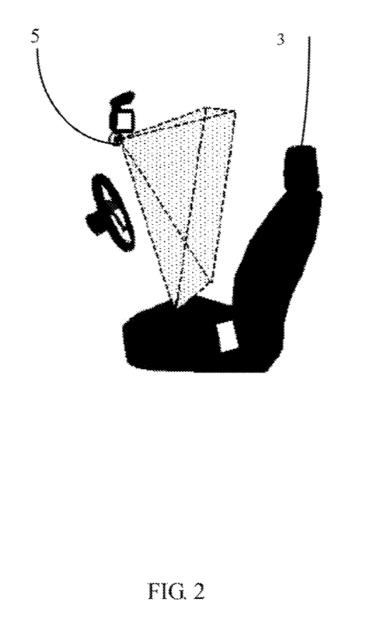

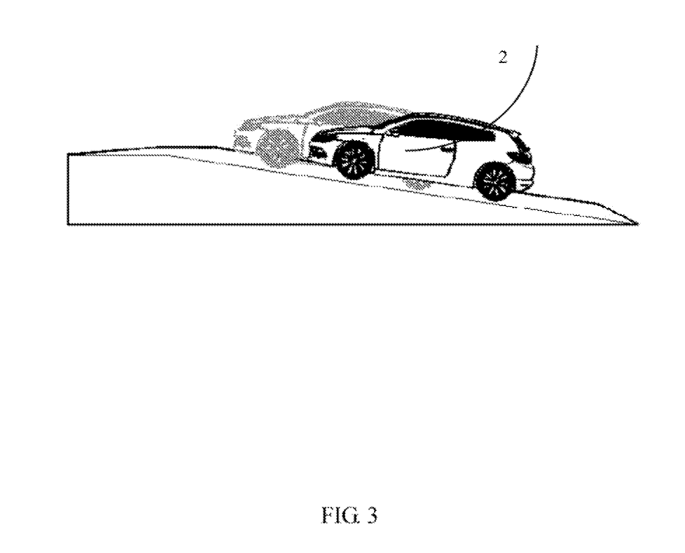

FIG. 1 shows an embodiment of a vehicle assistance device 1. The vehicle assistance device 1 is installed in a vehicle 2 (see FIG. 3). The vehicle assistance device 1 can stop the vehicle 2 from moving when no person is present in a driver's seat 3 (see FIG. 2) of the vehicle 2. The vehicle assistance device 1 is connected to a speed detection unit 4, a camera 5, a driving unit 6, a pushing unit 7, and a handbrake 8. The speed detection unit 4 is configured to detect a speed of the vehicle 2, and the camera 5 is configured to capture images of the driver's seat 3. The vehicle 2 includes the handbrake 8. The vehicle assistance device 1 determines whether the vehicle 2 is moving according to the speed of the vehicle 2 detected by the speed detection unit 4 while the vehicle 2 is parked, determines whether a person occupies the driver's seat 3 according to images captured by the camera 5 when the vehicle 2 is moving, and controls the driving unit 6 to drive the pushing unit 7 to engage the handbrake 8 of the vehicle 2 when no person occupies the driver's seat 3, thus stopping the vehicle 2 from moving.

Referring to FIG. 2, the camera 5 is located on a dashboard of the vehicle 2 and aimed at the driver's seat 3. The camera 5 captures the images of the driver's seat 3. In the illustrated embodiment, an area bound by the broken lines and filled with dotted lines is an area captured by the camera 5 (see FIG. 2). In the embodiment, the camera 5 is a Time of Flight (TOF) camera. Each captured image of the driver's seat 3 includes distance information indicating a distance between the camera 5 and each object captured by the camera 5.

In the embodiment, the vehicle assistance device 1 includes at least one processor 10 and a storage unit 20. A vehicle assistance system 30 is applied in the vehicle assistance device 1. In the embodiment, the vehicle assistance system 30 includes a speed obtaining module 31, a determining module 32, an image obtaining module 33, a model creating module 34, an image analyzing module 35, an executing module 36, and a releasing module 37. One or more programs of the above function modules may be stored in the storage unit 20 and executed by the processor 10. In general, the word “module,” as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device. The processor 10 can be a central processing unit, a digital processor, or a single chip, for example. The storage unit 20 can be a hard disk, a compact disk, or a flash memory, for example.

In the embodiment, the storage unit 20 stores a number of preset three-dimensional (3D) models of a person sitting in the driver's seat 3. Each preset 3D model has a unique name and a number of characteristic features. In one embodiment, the preset 3D models are created based on a number of images of the person sitting in the driver's seat 3 pre-collected by the camera 5 and the distance between the camera 5 and the person recorded in the pre-collected images of the special person. In the embodiment, when the images of the person are pre-collected by the camera 5, the person is sitting in the driver's seat 3 and facing toward the camera 5.

The speed obtaining module 31 obtains the speed of the vehicle 2 detected by the speed detection unit 4 when the vehicle 2 is parked.

The determining module 32 determines whether the vehicle 2 is moving according to the obtained speed of the vehicle 2. When the obtained speed of the vehicle 2 is greater than zero, the determining module 32 determines that the vehicle 2 is moving (See FIG. 3). When the obtained speed of the vehicle 2 is zero, the determining module 32 determines that the vehicle 2 is motionless.

The image obtaining module 33 obtains an image of the driver's seat 3 captured by the camera 5 every predetermined time interval when the determining module 32 determines that the vehicle 2 is moving.

The model creating module 34 creates a 3D model of the driver's seat 3 corresponding to the obtained image and the distance between the camera 5 and each object of the image captured by the camera 5.

The image analyzing module 35 determines whether a person occupies the driver's seat 3 according to the created 3D model of the driver's seat 3. In detail, the image analyzing module 35 extracts data from the created 3D model of the driver's seat 3 corresponding to shapes of the objects in the created 3D model of the driver's seat 3. The image analyzing module 35 compares the extracted data from the created 3D model of the driver's seat 3 with characteristic features of each of the preset 3D models to determine whether a person is in the created 3D model. If the extracted data of the 3D model does not match the characteristic features of any of the preset 3D models, the image analyzing module 35 determines that no person is in the created 3D model, and accordingly determines that no person occupies the driver's seat 3. If the extracted data from the created 3D model matches the characteristic features of at least one of the preset 3D models, the image analyzing module 35 determines that a person is in the created 3D model, and accordingly determines that a person occupies the driver's seat 3.

The executing module 36 controls the driving unit 6 to drive the pushing unit 7 to engage the handbrake 8 of the vehicle 2 when no person occupies the driver's seat 3.

In the embodiment, the image obtaining module 33 turns on the camera 5 only when the determining module 12 determines that the vehicle 2 is moving while the vehicle 2 is parked. Then, the image obtaining module 33 obtains the images captured by the camera 5 every predetermined time interval.

In the embodiment, the vehicle assistance device 1 is further connected to an input unit 9. The releasing module 37 controls the driving unit 6 to restore the pushing unit 7 to an initial state in response to a user operation on the input unit 9. Thus, after a person comes back to the vehicle 2 and inputs the user input on the input unit 9, the person can manually disengage the handbrake 8 of the vehicle 2.

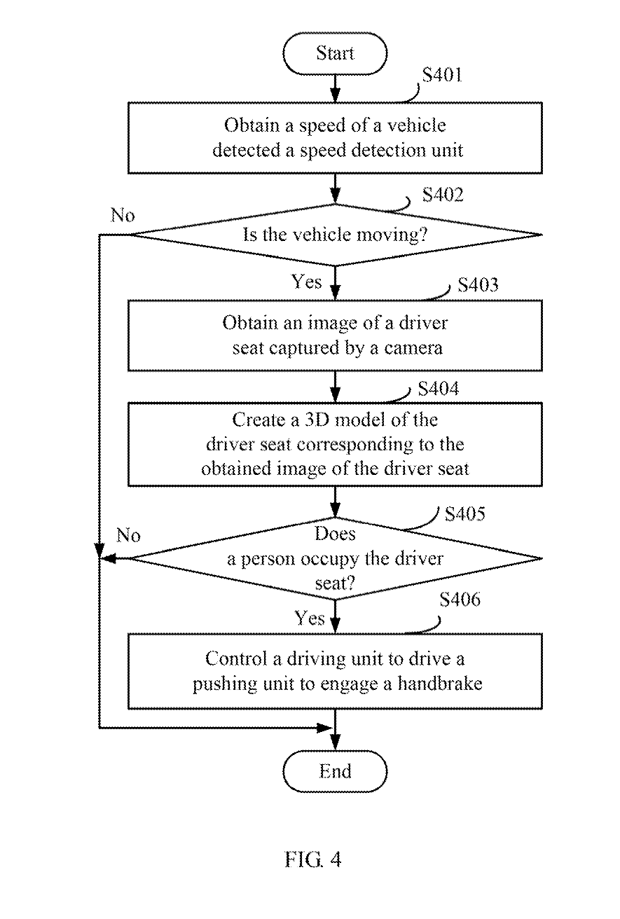

FIG. 4 shows a flowchart of a vehicle assistance method in accordance with an exemplary embodiment. The method may include additional steps, or omit some steps. Or the order of the steps may be different, and so on.

In step S401, when the vehicle 2 is parked, the speed obtaining module 31 obtains a speed of the vehicle 2 detected by the speed detection unit 4.

In step S402, the determining module 32 determines whether the vehicle 2 is moving according to the obtained speed of the vehicle 2. When the obtained speed of the vehicle 2 is greater than zero, the determining module 32 determines that the vehicle 2 is moving, and the procedure goes to step S403. When the obtained speed of the vehicle 2 is zero, the determining module 32 determines that the vehicle 2 is motionless, and the procedure ends.

In step S403, the image obtaining module 33 obtains an image of the driver's seat 3 captured by the camera 5 every predetermined time interval.

In step S404, the model creating module 34 creates a 3D model of the driver's seat 3 corresponding to the obtained image and the distance between the camera 5 and each object of the image captured by the camera 5.

In step S405, the image analyzing module 35 determines whether a person occupies the driver's seat 3 according to the created 3D model of the driver's seat 3. If no person occupies the driver's seat 3, the procedure goes to step S406. If a person occupies the driver's seat 3, the procedure ends. In detail, the image analyzing module 35 extracts data from the created 3D model of the driver's seat 3 corresponding to shapes of the objects in the created 3D model of the driver's seat 3. The image analyzing module 35 compares the extracted data from the created 3D model of the driver's seat 3 with characteristic features of each of the preset 3D models to determine whether a person is in the created 3D model. If the extracted data of the 3D model does not match the characteristic features of any of the preset 3D models, the image analyzing module 35 determines that no person is in the created 3D model, and accordingly determines that no person occupies the driver's seat 3. If the extracted data from the created 3D model matches the characteristic features of at least one of the preset 3D models, the image analyzing module 35 determines that a person is in the created 3D model, and accordingly determines that a person occupies the driver's seat 3.

In step S406, the executing module 36 controls a driving unit 6 to drive a pushing unit 7 to engage a handbrake 8 of the vehicle 2 when no person occupies the driver's seat 3.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A vehicle assistance device, comprising:
a storage system;
a processor;
one or more programs stored in the storage system, executable by the processor, the one or more programs comprising:
a speed obtaining module configured to obtain a speed of a vehicle detected by a speed detection unit when the vehicle is parked;
a determining module configured to determine whether the vehicle is moving according to the obtained speed of the vehicle;
an image obtaining module configured to obtain an image of a driver's seat of the vehicle captured by a camera every predetermined time interval when the determining module determines that the vehicle is moving; each of the images comprising a distance information indicating distances between the camera and each object captured by the camera;
a model creating module configured to creates a 3D model of the driver's seat corresponding to the obtained image and the distance between the camera and each object captured by the camera;
an image analyzing module configured to compare the created 3D model of the driver's seat with stored preset 3D models of a person sitting in the driver's seat to determine whether a person occupies the driver's seat; and
an executing module configured to control a driving unit to drive a pushing unit to engage a handbrake of the vehicle when no person occupies the driver's seat, causing the vehicle to stop moving.

2. The vehicle assistance device as described in claim 1, wherein the image analyzing module is configured to:
extract data from the created 3D model of the driver's seat corresponding to shapes of the objects in the created 3D model of the driver's seat, and compare the extracted data from the created 3D model of the driver's seat with characteristic features of each of the preset 3D models to determine whether a person is in the created 3D model of the driver's seat;
determine that no person is in the created 3D model of the driver's seat if the extracted data from the created 3D model of the driver's seat does not match the characteristic features of any of the preset 3D models, and accordingly determine that no person occupies the driver's seat; and
determine that a person is in the created 3D model of the driver's seat if the extracted data from the created 3D model of the driver's seat matches the characteristic features of at least one of the preset 3D models, and accordingly determine that a person occupies the driver's seat.

3. The vehicle assistance device as described in claim 1, wherein the image obtaining module is further configured to turn on the camera to capture the image when determining module determines that the vehicle is moving while the vehicle is parked, and then obtain the image captured by the camera every predetermined time interval.

4. The vehicle assistance device as described in claim 1, further comprising a releasing module, wherein the releasing module is configured to control the driving unit to restore the pushing unit to an initial state in response to a user operation on an input unit.

5. The vehicle assistance device as described in claim 1, wherein the determining module is configured to determine that the vehicle is moving when the obtained speed of the vehicle is greater than zero, and is configured to determine that the vehicle is motionless when the obtained speed of the vehicle is zero.

6. A vehicle assistance method comprising:
obtaining a speed of a vehicle detected by a speed detection unit when the vehicle is parked;
determining whether the vehicle is moving according to the obtained speed of the vehicle;
obtaining an image of a driver's seat of the vehicle captured by a camera every predetermined time interval when determining that the vehicle is moving; each of the images comprising a distance information indicating distances between the camera and each object captured by the camera;
creating a 3D model of the driver's seat corresponding to the obtained image and the distance between the camera and each object captured by the camera;
comparing the created 3D model of the driver's seat with stored preset 3D models of a person sitting in the driver's seat to determine whether a person occupies the driver's seat; and
controlling a driving unit to drive a pushing unit to engage a handbrake of the vehicle when no person occupies the driver's seat, causing the vehicle to stop moving.

7. The vehicle assistance method as described in claim 6, wherein the step of “comparing the created 3D model of the driver's seat with stored preset 3D models of a person sitting in the driver's seat to determine whether no person occupies the driver's seat” comprises:
extracting data from the created 3D model of the driver's seat corresponding to shapes of the objects in the created 3D model of the driver's seat, and comparing the extracted data from the created 3D model of the driver's seat with characteristic features of each of the preset 3D models to determine whether a person is in the created 3D model of the driver's seat;
determining that no person is in the created 3D model of the driver's seat if the extracted data from the created 3D model of the driver's seat does not match the characteristic features of any of the preset 3D models, and accordingly determining that no person occupies the driver's seat; and
determining that a person is in the created 3D model of the driver's seat if the extracted data from the created 3D model of the driver's seat matches the characteristic features of at least one of the preset 3D models, and accordingly determining that a person occupies the driver's seat.

8. The vehicle assistance method as described in claim 6, wherein the method further comprises:
turning on the camera to capture the image when determining that the vehicle is moving while the vehicle is parked, and then obtaining the image captured by the camera every predetermined time interval.

9. The vehicle assistance method as described in claim 6, wherein the method further comprises:
controlling the driving unit to restore the pushing unit to an initial state in response to a user operation on an input unit.

10. The vehicle assistance method as described in claim 6, wherein the method further comprises:
determining that the vehicle is moving when the obtained speed of the vehicle is greater than zero; and
determining that the vehicle is motionless when the obtained speed of the vehicle is zero.

11. A non-transitory storage medium storing a set of instructions, the set of instructions capable of being executed by a processor of a vehicle assistance device, causing the vehicle assistance device to perform a vehicle assistance method, the method comprising:
obtaining a speed of a vehicle detected by a speed detection unit when the vehicle is parked;
determining whether the vehicle is moving according to the obtained speed of the vehicle;
obtaining an image of a driver's seat of the vehicle captured by a camera every predetermined time interval when determining that the vehicle is moving; each of the images comprising a distance information indicating distances between the camera and each object captured by the camera;
creating a 3D model of the driver's seat corresponding to the obtained image and the distance between the camera and each object captured by the camera;
comparing the created 3D model of the driver's seat with stored preset 3D models of a person sitting in the driver's seat to determine whether a person occupies the driver's seat; and
controlling a driving unit to drive a pushing unit to engage a handbrake of the vehicle when no person occupies the driver's seat, causing the vehicle to stop moving.

12. The non-transitory storage medium as described in claim 11, wherein the step of “comparing the created 3D model of the driver's seat with stored preset 3D models of a person sitting in the driver's seat to determine whether no person occupies the driver's seat” comprises:
extracting data from the created 3D model of the driver's seat corresponding to shapes of the objects in the created 3D model of the driver's seat, and comparing the extracted data from the created 3D model of the driver's seat with characteristic features of each of the preset 3D models to determine whether a person is in the created 3D model of the driver's seat;
determining that no person is in the created 3D model of the driver's seat if the extracted data from the created 3D model of the driver's seat does not match the characteristic features of any of the preset 3D models, and accordingly determining that no person occupies the driver's seat; and
determining that a person is in the created 3D model of the driver's seat if the extracted data from the created 3D model of the driver's seat matches the characteristic features of at least one of the preset 3D models, and accordingly determining that a person occupies the driver's seat.

13. The non-transitory storage medium as described in claim 11, wherein the method further comprises:
turning on the camera to capture the image when determining that the vehicle is moving while the vehicle is parked, and then obtaining the image captured by the camera every predetermined time interval.

14. The non-transitory storage medium as described in claim 11, wherein the method further comprises;
controlling the driving unit to restore the pushing unit to an initial state in response to a user operation on an input unit.

15. The non-transitory storage medium as described in claim 11, wherein the method further comprises:
determining that the vehicle is moving when the obtained speed of the vehicle is greater than zero; and
determining that the vehicle is motionless when the obtained speed of the vehicle is zero.
